(19) United States
(12) Patent Application Publication
(10) Pub. No.: US 2003/0088620 A1
(43) Pub. Date: May 8, 2003

(54) Scaleable message dissemination system and method

(75) Inventors: Anne-Marie Kermarrec, Cambridge (GB); Ayalvadi Jagannathan Ganesh, Cambridge (GB); Laurent Massoulie, Cambridge (GB)

Correspondence Address: Timothy B. Scull, Merchant & Gould P.C., P.O. Box 2903, Minneapolis, MN, 55402-0903, US

(73) Assignee: Microsoft Corporation

(21) Appl. No.: 09/992,862

(22) Filed: Nov. 5, 2001

(51) Int. Cl. G06F 15/16

(52) U.S. Cl. 709/204

(57) ABSTRACT

A system and method for the dissemination of information to a plurality of nodes, the nodes connected in a network environment. Each node maintains a partial view of the network that identifies some of the other network nodes. The act of sending the message to a plurality of nodes further comprises delivery of the message to all nodes identified in the partial view. The partial view is created through a decentralized subscription process.

### FIELD OF THE INVENTION

The present invention relates to the dissemination of messages and/or events in a distributed network between nodes on the network. More particularly, the present invention relates to a system and method for application-level broadcasting or multi-casting the messages to many, if not all nodes in the distributed network in a decentralized manner, e.g., by using a gossip-based method. More precisely, the invention relates to maintaining membership information needed for the implementation of gossip-based broadcast.

### BACKGROUND OF THE INVENTION

In distributed networks or systems having many connected nodes or processes, communication methods used between the nodes is important, especially as the networks become relatively large. Furthermore, the methods of communication become significantly important from a performance standpoint for particular types of communication, such the broadcasting of information to all connected and operable nodes of the network. Broadcasting, also referred to as multi-casting, involves transmitting event or message information along the network in a manner that results in all nodes on the network receiving the information.

One method of broadcasting information requires storing information related to all the nodes centralized in one server-type computer system. The server-type system uses the list of all nodes to control the broadcast of information to all nodes by simply transmitting the information to each listed node. The server-type systems, in this example typically maintain the catalog of information of all nodes connected across the network. Unfortunately however, this centralized protocol does not scale easily. That is, as the number of nodes on the network increases, the maintenance of such an increasingly large list becomes prohibitive. Additionally, the dissemination of information relies heavily on the operability of the one or few systems maintaining the catalog of information. Should the systems maintaining the catalog of information fail, the information will not be disseminated as desired.

One solution to the issues with centralized protocols relates to decentralized communication algorithms housed within each node, i.e., an application-level system, wherein each node manages a relatively small portion of the overall broadcast transfer of information by transmitting received information to other, neighboring nodes. Typical application-level systems are referred to as gossip-based algorithms since each receiving node is responsible for passing the information on to some of the other nodes. Gossip-based protocols essentially rely on one primary assumption: when a node receives a new message, the receiving node forwards the message to a random collection of other nodes. In a typical scenario, each node that receives the information is responsible for conducting the information on to a predetermined number of other nodes, e.g., ten other neighboring nodes in a network having one hundred thousand nodes. Furthermore, gossip-based algorithms do not require back-and-forth communication between nodes, which would significantly impact performance. Instead, each node simply passes the information along without attempting to determine if the receiving node has already received the information.

A well-recognized issue surrounding gossip-based broadcasting methods relates to the probability that all nodes in the network receive event information as intended. It is also recognized that in order to insure a high probability that all nodes receive the intended information, each gossiping node must pass the information on to a sufficient number of other nodes. Existing gossip-based protocols determine the sufficient number of nodes by analyzing characteristics of the entire network, i.e., the size of the network. In order to determine the size of the network, typical protocols require the maintenance of a list or some other catalog of information relating to the entire network. In one particular gossip protocol, each node maintains such a list, thereby providing the nodes with a view or understanding of the network size. Having an understanding of the entire network provides each node the ability to determine how many other nodes to forward messages in order to achieve a given probability for a successful broadcast. The node then randomly selects the proper number of nodes from its view of the network and disseminates the information to those nodes.

Unfortunately however, maintaining such information within each node reduces scalability for the gossip algorithm since each node must maintain a significant amount of information. In essence, as the network grows, the amount of information that must be stored on each node grows linearly. Maintaining such a large amount of information on each node significantly impacts performance, which becomes unacceptable, if not prohibitive, as the network grows appreciably larger.

It is with respect to these and other considerations that the present invention has been made.

### SUMMARY OF THE INVENTION

The present invention relates to a system and method of decentralized gossip-based message dissemination and more specifically to how membership information is maintained. The system and method incorporates, within each node, a partial view of the entire network system. Using its partial view, each node disseminates information in a gossip-based approach by transmitting received information to all nodes identified in its partial view. The partial view, therefore, identifies the number of nodes necessary to insure a high probability of success in disseminating information to all nodes on the network, which may be significantly fewer nodes as compared to the overall number of nodes on the network. The partial view changes as the network grows through a membership algorithm that is decentralized. The membership algorithm provides for the convergence of partial view size for each node so each node has approximately the same number of nodes in its partial view and that number of nodes is a number related to high probability of success.

In accordance with particular aspects, the present invention relates to a system and method for the dissemination of information to a plurality of nodes, the nodes connected in a network environment. Initially, a node receives a disseminated message that needs to be broadcast to all nodes in the system and then the node sends the received message to a plurality of other nodes identified in a partial view, wherein the partial view resides locally on the node and identifies some of the other network nodes. The act of sending the message to a plurality of nodes further comprises delivery of the message to all nodes identified in the partial view. Additionally, each other node in the network maintains a partial view and disseminates information to nodes identified in their respective partial views.

In accordance with other aspects, the present invention relates to the use and creation of a partial view that has address information for a plurality of nodes on the network, but less than all nodes on the network. In creating the partial view, a node may receive a subscription request, keep the information related to the new node from an analysis of the subscription request and forward the subscription request message to all nodes in the existing partial view. Additionally, should a node receive a forwarded subscription request, the node may determine whether to keep the new subscription request based on predetermined criterion. If the predetermined criterion is satisfied, the node keeps the new subscription request and if not satisfied, the node forwards the subscription request to another node. In one embodiment, the predetermined criterion relates to a probability value that is inversely proportional to the size of the partial view for the existing node.

In accordance with other aspects, the present invention relates to recovering an isolated node in a network environment by using an isolation detection timer. Each node maintains such an isolation detection timer. Upon receipt of a message, the receiving node recognizes that isolation has not occurred and resets its isolation detection timer. If, however, the isolation detection timer expires before receiving another message, the node recognizes that it may be isolated and resubscribes by sending another subscription request to a node identified in the partial view of the isolated node. In an embodiment, dummy messages may be broadcast to other nodes in the environment to prevent premature isolation. In accordance with a particular embodiment, each node maintains a second timer, a heartbeat timer. The heartbeat timer is reset to a predetermined value each time a node broadcasts a message to all the members of its partial view to effectively restart the isolation detection timers of those other nodes, assuming those nodes are still connected. The heartbeat timer may be set to shorter time value than the isolation detection timer.

The invention may be implemented as a computer process, a computing system or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its improvements can be obtained by reference to the accompanying drawings, which are briefly summarized below, to the following detail description of presently preferred embodiments of the invention, and to the appended claims.

### BRIEF DESCRIPTION OF THE DRAWINGS

FIG. 1 illustrates a communication or distributed network of nodes that incorporates aspects of the present invention.

FIG. 2 illustrates a computer system that may be used according to particular aspects of the present invention.

FIG. 3 illustrates a partial view of the network maintained by a node in the network.

FIG. 4 illustrates a flow chart of functional operations related to the dissemination of information according to aspects of the present invention.

FIG. 5 illustrates a flow chart of operational characteristics of the present invention with respect to membership request when received by a first node.

FIG. 6 illustrates a flow chart of operational characteristics of the present invention with respect to membership request when received by a subsequent node.

FIG. 7 illustrates a flow chart of functional operations related to recapturing a lost or isolated node.

FIG. 8 illustrates a data structure of a message that may be conducted between nodes of the network shown in FIG. 1.

### DETAILED DESCRIPTION OF THE PREFERRED EMBODIMENT

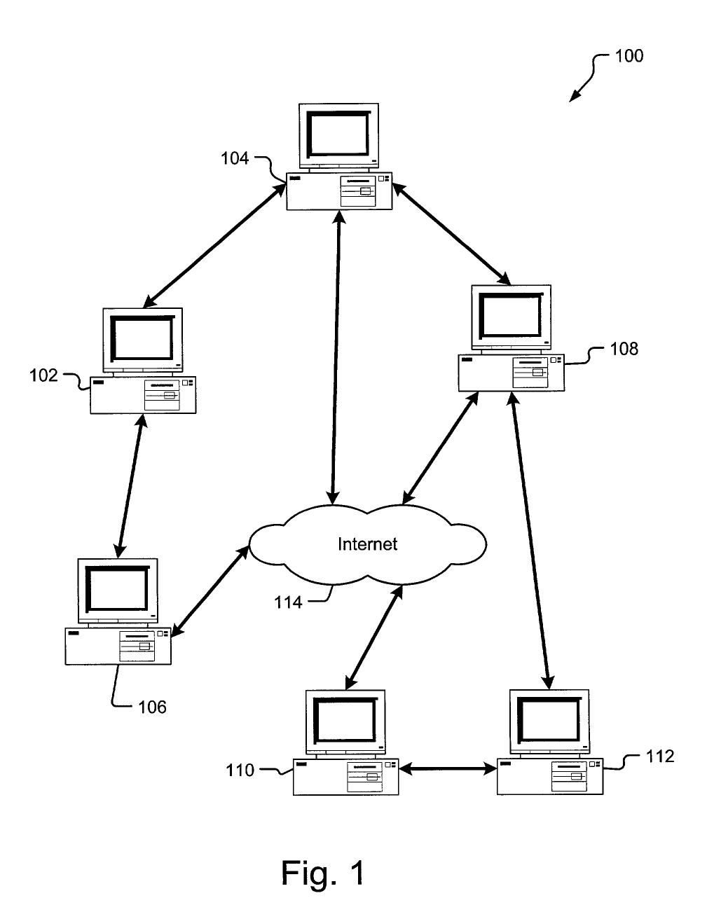

A distributed environment 100 incorporating aspects of the present invention is shown in FIG. 1. The environment 100 has at least one computer system 102 and potentially other computer systems such as 104, 106, 108, 110, and 112, wherein the various computer systems are referred to as nodes. In an embodiment of the invention, each node maintains a partial view of the network environment 100 and disseminates broadcast information via a gossip-based algorithm. Moreover, each node generally only disseminates information to the nodes represented in its partial view of the network, such that each node does not disseminate information to other nodes not represented in its partial view of the network, as discussed more completely below. The partial view approach decentralizes the network information and, utilizing gossip-based dissemination, maintains a high probability that all nodes will receive a broadcast message or event.

As stated, each of the computer systems 102, 104, 106, 108, 110 and 112 are considered nodes within the environment 100. With respect to the present application, the nodes, such as 102, 104, 106, 108, 110 and 112 are process elements capable of storing some information related to other nodes and communicating with other nodes within the environment 100. Although shown as computer systems, nodes 102, 104, 106, 108, 110 and 112 may be computer processes within a computer system. Alternatively, the nodes 102, 104, 106, 108, 110 and 112 may combine a combination of separate computer systems distributed across a local area network, wide area network, or a combination of separate network communications. Furthermore, the nodes may communicate via separate protocols such as TCP/IP or other network and/or communication protocols, implemented over networks such as the Internet 114. That is, although shown as connected by seemingly direct arrows, the separate nodes 102, 104, 106, 108, 110 and 112 may in fact be in communication with other nodes via other indirect ways. Indeed, the connections shown in 100 merely indicate that a node may communicate with another node.

Communication between nodes 102, 104, 106, 108, 110 and 112 may be achieved, as stated, by many communication protocols. The definition of a communication used herein relates to the transfer of a message, an event, or any other information from one node to another. In an embodiment, the nodes of environment 100 may be able to communicate with all other nodes in the network 100, but such a requirement is not necessary. In order to communicate information from a sending node to another, receiving node, the sending node needs the network address or some other identifying information for the receiving node. Using the identifying information, the sending node may send the information using any transfer protocol.

Within the environment shown in FIG. 1, according to the present invention, each node 102, 104, 106, 108, 110 and 112 maintains a partial view of the environment 100, i.e., a list of identifying information for less than all the nodes in the environment 100. The partial view, therefore, relates to a list of addresses for some of the other nodes within the environment 100. In an alternative embodiment, all nodes 102, 104, 106, 108, 110 and 112 maintain lists or sets of information related to other nodes in the environment wherein each set of information relates to less than all of the nodes in the environment 100. As an example, node 102 may have information related to nodes 104 and 106 but no information as to nodes 108, 110 and 112. Similarly, node 104 may have communication information relating to nodes 102, 106 and 108, but no information relating to nodes 110 and 112, and so on.

During dissemination of information throughout the network environment 100, each node 102, 104, 106, 108, 110 and 112 disseminates information to each node within its partial view, or alternatively, to a subset of nodes within its partial view. The delivery of information to a subset of the entire network is part of a gossip-based approach to disseminating information wherein each node passes information to other nodes upon receipt of that information. Furthermore, as long as the partial view for each node has information for a sufficient number of nodes, then there is a high probability that each node within the network shall receive the disseminated information.

Although only six nodes 102, 104, 106, 108, 110 and 112 are shown in FIG. 1, the network environment may include other nodes. Indeed, the number of nodes for environment 100 may be quite extensive incorporating thousands, to tens of thousands of nodes. Hence, the present invention is beneficial in scaling the environment 100 as needed so that practically any number of nodes may communicate information according to the present invention. Moreover, the nodes need not maintain a list of all other nodes in the environment 100.

As will be discussed in more detail below, when a new node is added to the environment 100, then a predetermined number of nodes, depending on the characteristics of the system, receive information indicating that a new node is present on the network or within the environment 100. Importantly, the number of nodes that actually maintain or keep communication information related to the new node is less than the total number of all nodes within the environment 100. Thus, in an embodiment, no one node has communication information related to all nodes within the system or environment 100.

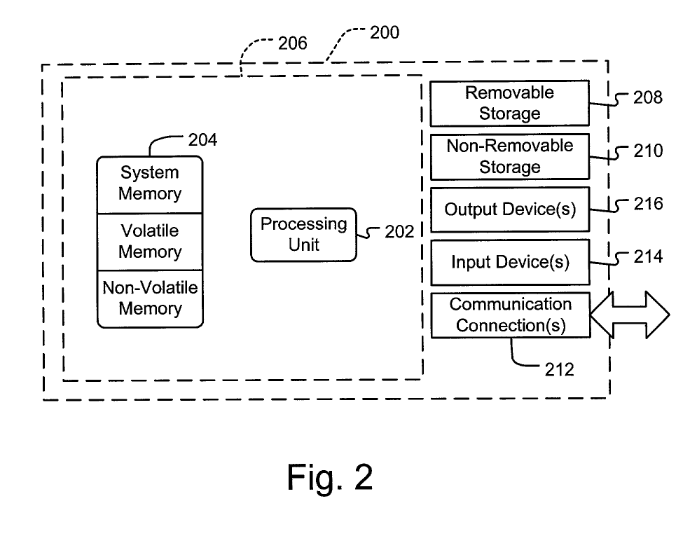

A computer system 200 that may represent one of the nodes, such as 102 shown in FIG. 1, which stores a partial view of the distributed network and disseminates information in accordance with the present invention, is shown in FIG. 2. The system 200 has at least one processor 202 and a memory 204. The processor 202 uses memory 204 to store the partial view of information related to a subset of other nodes in the network.

In its most basic configuration, computing system 200 is illustrated in FIG. 2 by dashed line 206. Additionally, system 200 may also include additional storage (removable and/or non-removable) including, but not limited to, magnetic or optical disks or tape. Such additional storage is illustrated in FIG. 2 by removable storage 208 and non-removable storage 210. Computer storage media includes volatile and nonvolatile, removable and non-removable media implemented in any method or technology for storage of information such as computer readable instructions, data structures, program modules or other data. Memory 204, removable storage 208 and non-removable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by system 200. Any such computer storage media may be part of system 200. Depending on the configuration and type of computing device, memory 204 may be volatile, non-volatile or some combination of the two.

System 200 may also contain communications connection(s) 212 that allow the device to communicate with other devices, such as other nodes 104, 106, 108, 110 or 112 shown in FIG. 1. Additionally, system 200 may have input device(s) 214 such as keyboard, mouse, pen, voice input device, touch input device, etc. Output device(s) 216 such as a display, speakers, printer, etc. may also be included. All these devices are well known in the art and need not be discussed at length here.

Computer system 200 typically includes at least some form of computer readable media. Computer readable media can be any available media that can be accessed by system 200. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by system 200. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

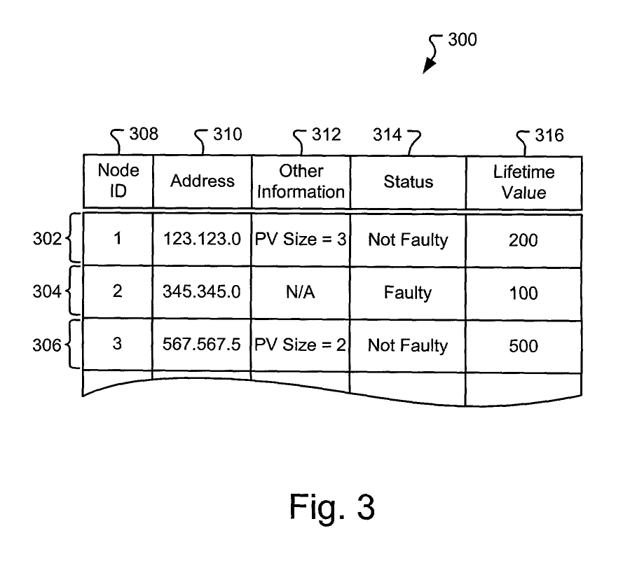

FIG. 3 illustrates an example of a local or partial view 300 maintained by a node, such as node 102 in a distributed network, such as network 100 shown in FIG. 1. The partial view 300 incorporates the identifying information relating to other nodes on the network 100. Importantly, the partial view does not contain a list of all other nodes on the network. The partial view or list 300 is used during information dissemination, where the node maintaining the list 300 disseminates information to all registered members in the partial view 300.

The view 300 contains information relating to other nodes so that information can be transmitted to the other nodes. The partial view 300 is an example of such a list of information that includes three entries 302, 304 and 306, wherein each entry relates to another node in the network. The partial view 300 may include a node identification or “ID” value 308 for each entry. The node ID value may provide quick information such as how many entries are in the list. The node ID may also provide other useful information relating to the communication between nodes.

The partial view 300 includes address information 310 for each entry. In an embodiment, the address information relates to the IP address that can be used to communicate directly with the other node.

In alternative embodiments, the partial view 300 may include other information related to the other network nodes, such as the partial view size 312 for the other nodes or possibly the status 314 of the other nodes, e.g., whether a node is known to be faulty. These other fields of the partial view are not necessary in that the dissemination of information to the entries in the partial view typically only requires the address information for the other nodes. However, in maintaining the partial view, other fields, such as fields 308, 312 and 314 may be useful.

In a particular embodiment, an additional field 316 may be stored in the partial view 300, the field 316 relating to a “lifetime value.” Essentially, each node that subscribes to the system may, in some embodiments, provide an expected lifetime value 316 indicating the amount of time that the node expects or desires to remain connected and to thereby receive messages.

The lifetime value may be stored in lifetime value field 316 in each of the nodes having information for the subscribing node. A timer for each node may then be set to the value indicated in field 316 and, upon expiration of the timer, the node information is removed from the partial view 300. This property provides a means to remove node information from various partial views in situations where the node is no longer active but has not unsubscribed. Since the subscribing node knows its associated lifetime value, because it set the value during its initial connection to the system, the subscribing node can recognize when the lifetime value will expire so that it may resubscribe and remain connected, if desired.

In an alternative embodiment, the nodes do not choose their lifetime value. Instead, the lifetime value is a parameter of the system, such as system 100 shown in FIG. 1. In such a case, all nodes may have the same lifetime value. Importantly however, each node would know this parameter so that it can resubscribe before the other nodes remove the node from their partial views. In yet other embodiments, the system may combine different combinations of system-provided lifetime values or node-chosen lifetime values. Again, in each case, the node recognizes the lifetime value so that the node may predict the time at which it will be removed from other partial views.

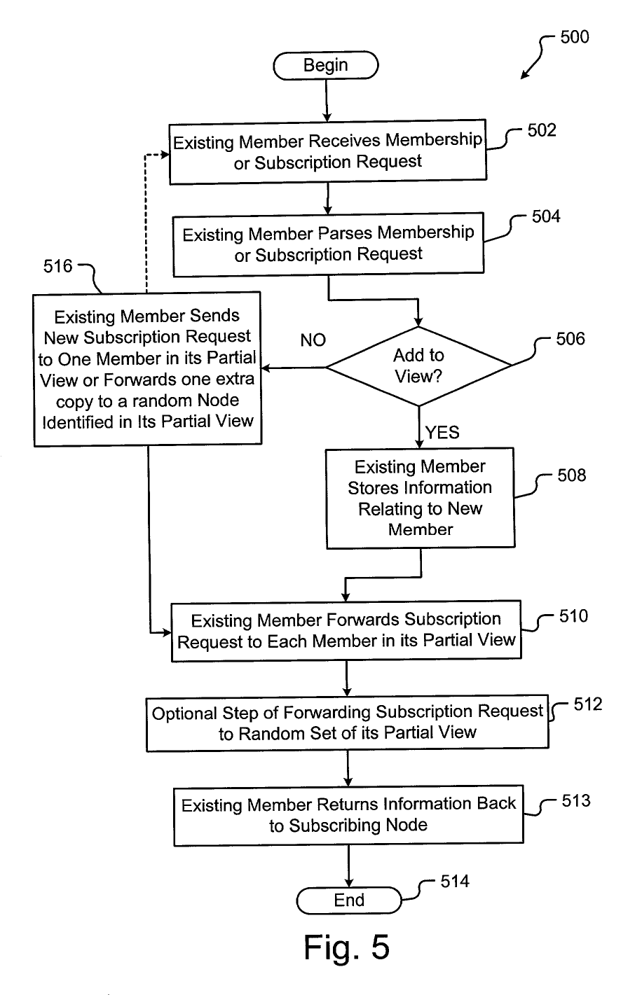

As mentioned above, the partial view 300 is populated as subscription or membership requests are received from new nodes. A method of populating the view is described below in conjunction with FIG. 5 wherein a new node requires membership and a predetermined number of nodes essentially add that new node or its information to their partial view. Alternative methods of populating the partial views may also be used. The size of the partial view should be sufficiently large to ensure a high probability that all nodes receive disseminated information. In one embodiment, the size of each partial view should be approximately log(n), where “n” relates to the number of nodes in the network and log refers to the natural logarithm. Alternatively, the size of the partial view 300 could be log(n) times a constant value “c”, where “c” relates to a predetermined value. The constant “c” may be included to allot for errors in operable nodes as discussed in more detail below.

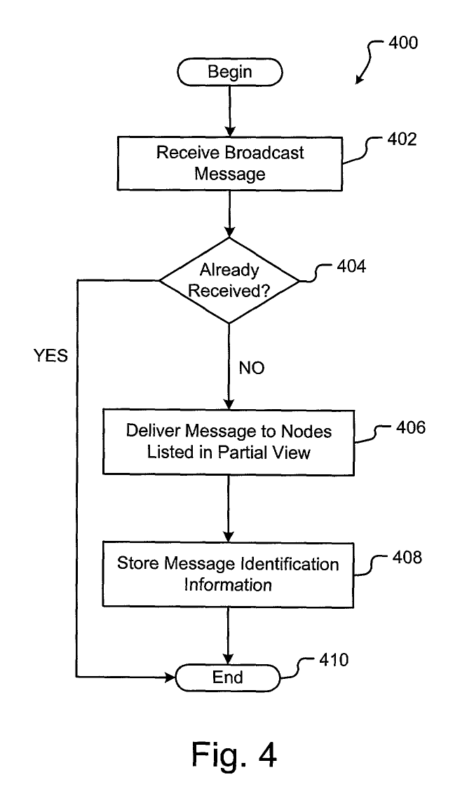

FIG. 4 illustrates the functional components related to disseminating broadcast information to multiple nodes. Flow 400 generally relates to the process performed by each node, such as node 104 shown in FIG. 1, as the node receives and disseminates broadcast information to all nodes in the network. Flow 400 begins with receive operation 402, indicating that a broadcast message has been received. The message may include information identifying the message as a broadcast message such that the receiving node recognizes that the message must be delivered to other nodes.

Following the receipt of the message, determination operation 404 determines whether the message has already been received and hence disseminated. Determination operation 404 essentially evaluates the message and determines if the message is similar to or the same as any earlier messages. The purpose for the determination is to prevent broadcasting the same message more than once.

If determination operation 404 determines that the received message is new, and has not been received before, then flow branches NO to deliver operation 406. In an embodiment, deliver operation 406 simply delivers the received message to each of the nodes listed in its partial view, where the partial view is a list of node addresses as discussed above in conjunction with FIG. 3. In this embodiment, there is no random selection of nodes to which the message must be delivered. Consequently, there is little to no overhead in determining which nodes to deliver the message. Alternative embodiments however may include a determination as to whether a subset of nodes should receive the message, and thus which subset of nodes.

Following delivery operation 406, store operation 408 stores message identification information. Store operation 408 provides a means of determining whether the message has been previously received. Therefore, determination operation 404 may use the stored information to test against future messages that may be received. Store operation 408 is an optional step as other means may be used to identify whether a particular message has been previously received.

Once the message identification information has been stored, flow 400 ends at end operation 410. Similarly, if determination operation 404 determines that the received message has already been received, and thus delivered to other nodes, then flow branches YES to end operation 410.

FIG. 5 illustrates the functional operations related to membership management according to the present invention. More particularly, flow 500 relates to the addition of a new node to a network environment, such as environment 100 shown in FIG. 1, such that the new node will receive event or other message information that is disseminated throughout the environment. As used herein, a “new” subscription request is handled differently from a “forwarded” subscription request. A new subscription request relates to a request received from a new node and a forwarded subscription relates to the forwarding of a subscription request received from an existing node.

Flow 500 begins with receive request 502 wherein an old or existing member of the environment receives a membership or subscription request from the new node. Importantly, the subscription request received by the existing node comprises information relating to the communication or address information for the new node, as well as an indication that the new node requests a subscription or membership to the environment. Additionally, the new node may have the ability or comprehension of the environment related to the gossip-based protocol used in disseminating information.

Following receipt of the subscription request from the new node, the existing member parses the subscription request during parse operation 504. Parse operation 504 evaluates the request and determines that a new membership request has been received and may further determine whether the identification information for the requesting node has been adequately provided.

Following parse operation 504, determination operation 506 determines whether the new node and its identifying information should be added to the partial view of the existing member. The determination may be based on whether the partial view for the receiving node has too many nodes such that the new node should not be added to its partial view. However, in an alternative embodiment, the new node is automatically added to the partial view for the receiving node. In such an embodiment, therefore, the first node that receives a new subscription request automatically adds the information for that new mode to the partial view of the receiving node.

If determination operation 506 determines that the new node should be added to the partial view of the existing member at determination operation 506, flow branches YES to store information operation 508. Store information operation 508 stores the identification information relating to the new member within the partial view of the existing member.

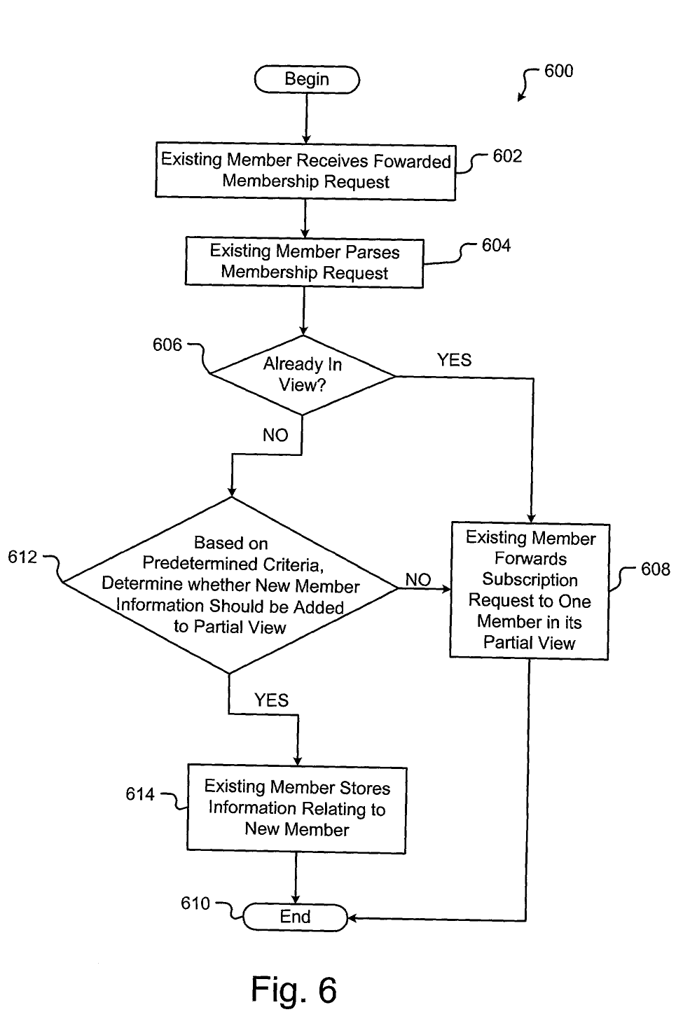

Upon storing the new information in the partial view for the existing member, forward operation 510 forwards the membership or subscription request for the new member to each existing member in its partial view. Forwarding this information may further include a request to add the new node to the receiving member's partial view. The forwarded subscription request is, however, identified as a forwarded subscription so as to inform the receiving member that it is a forwarded subscription and not a new subscription. Therefore, the receiving member does not attempt to forward the subscription to all members in its partial view, as in a broadcast situation. Upon receiving the forwarded subscription, the receiving member operates according to flow 600 shown in FIG. 6 and described below.

Following forward operation 510, an optional forward operation 512 may be performed wherein duplicates of the new node identification is forwarded to a random subset of the partial view. Therefore, the same subscription request is sent in duplicate to at least some of the members within the partial view. In a particular embodiment, this subset is randomly picked, however, alternative embodiments may predetermine which subset of the partial view is to receive the duplicate IDs. The purpose for forwarding duplicate subscription IDs is to allow the receiving member of the duplicate ID to forward the subscription on to yet another one or more members within its partial view. In doing so, a level of redundancy is implemented in the system by increasing the number of nodes containing the identification information for the new node. As stated, increasing the number of nodes that have any information related to each of the other nodes within the environment increases the probability that all nodes will receive a broadcast message. In alternative embodiments, however, such duplication is not used.

In addition to sending information to other, existing members within the partial view as indicated by operations 510 and 512, return operation 513 may be implemented to return information back to the subscribing node. Essentially, the subscribing node should create and maintain a partial view as the other nodes. The return of information from the existing node handling the new subscription request may initialize the partial view for the new member. That is, once an existing node receives a subscription request and adds the new node information to its partial view (operation 508), a message is returned to the new subscriber that relays the fact that the request is being handled and indicates a request or command to add the information relating to the existing member to the new node's partial view. Following return operation 513, flow ends at operation 514.

Referring back to determination operation 506, if determination operation 506 determines that the new node information should not be added to its partial view, flow branches NO to send operation 516. In one embodiment, send operation 516 sends the new subscription request to one existing member in its partial view. In this case, the subscription request is not treated as a forwarded message. Instead, the member that receives the message treats the message as new subscription request as if it received the request directly from the new node. Hence, flow 500 would begin again with the receipt of the new subscription request as indicated by the dashed arrow. Eventually, a node will accept the new node subscription and flow will branch to store operation 508.

In an alternative embodiment, the operation 516 does not forward the new subscription but instead forwards one extra copy of the new node information to one node within the partial view. Following the forwarding of the new node information to the one extra node, flow branches to forward operation 510. Forwarding one extra copy essentially ensures that the proper number of nodes within the environment receive and store the identifying information for the new node.

Pseudo-code for an embodiment of the invention related to the subscription management of a node receiving a new subscription is shown in Table 1.

TABLE 1
Subscription Management Pseudo-Code

Title: Subscription management
Pseudo Code:
Upon subscription (s) of a new subscriber on node n
Initial Randomization, decides whether the subscription is
treated locally or by another node
P =RandomBetween0And1 ()
Provides a random number between 0 and 1
if (p>threshold)

Threshold is a design parameter
randomNode=RandomChoice(SizeOfPartialView);
RandomChoice chooses randomly an integer between 1 and
SizeOfPartialView
Send(Partialview[randomNode],s,newSusbcription);

Else
{
The subscription of s is forwarded to all the nodes of view
for (i=0; i<SizeofPartialView; i++) do
For each node n in View
Send(PartialView[i],s,forwardedSusbcription);
Format of Send (destination, payload, message type
end for
{c additional copies of the subscription s are forwarded to
random nodes of view}
for (j=0; j<c;j++) do
randomNode=RandomChoice(SizeOfPartialView);
RandomChoice chooses randomly an integer between 1 and
SizeOfPartialView
Send(Partialview[randomNode],s,forwardedSusbcription);
end for
}

As indicated in Table 1, a determination may be made as to whether the existing or receiving node should treat the request for the new subscription. The determination operation may be performed as part of determination operation 506 described above. In this embodiment, a threshold value, which is a design parameter, may be set, e.g., a number between 0 and 1. Next, when a new subscription request is received, a random number is generated, such as a number between 0 and 1. The generated random number is then compared to the threshold value to determine whether the receiving node should treat the request or pass the request to another node, e.g., as described with respect to operation 516. Using the example from Table 1, when the threshold value is equal to 1, new subscriptions are always treated by the node who first received the subscription request since any random number chosen between 0 and 1 will be less than or equal to the threshold value of 1. This may be a suitable solution in an environment where new subscribers are expected to pick randomly the node they subscribe to. In an environment where every node subscribes to the same node, a suitable value for threshold would be much smaller for instance 0.01, such that the receiving node is unlikely to handle the request since most random numbers chosen between 0 and 1 should be greater than the threshold value.

FIG. 6 illustrates the functional operations related to handling of a forwarded subscription request. Flow 600 begins with receive operation 602. Receive operation 602 receives the forwarded membership request. In an embodiment, the membership request is received by an existing member and from an existing member within the environment 100.

Following receive operation 602, parse operation 604 parses the forwarded membership request. In essence, since each node handles forwarded subscription requests differently from new subscription requests, parsing operation 604 is needed to parse and evaluate the membership request to determine whether the request is forwarded or new. Following parse operation 604, determination operation 606 determines whether the new node information has already been stored within the partial view of the receiving node. In this case, the receiving node has an existing partial view that includes information related to various other nodes in the environment. Determination operation 606 may essentially compare the address information for the requesting node against the address information for the existing nodes within the receiving nodes partial view. This comparison determines whether the existing node already has the new node information within its partial view.

If determination operation 606 determines that the partial view already contains information related to the new node, flow branches YES to forward operation 608. Forward operation 608 forwards the new subscription request to one member in its partial view. Essentially the existing member does not store a second copy of the new member information and, therefore, chooses one existing node in the environment to forward the information to. The information may be sent to any node within the partial view of the existing node, but preferably is not sent to the new node. Determining which node to send the new node information on to may be performed by random selection or by a predetermined selection. Following forward operation 608, flow 600 ends at end operation 610.

If determination operation 606 determines that the new node information is not in the partial view, flow branches NO to test operation 612. Test operation 612 tests whether the new member information should be added to the partial view, i.e., whether the forwarded subscription should be kept and not forwarded on to another node. In this case the test operation 612 evaluates the existing partial view against predetermined criteria to evaluate whether the new member should be added. One method of determining whether the subscription should be kept relates to “tossing a coin” or generating a random number and adding the information if the random number is odd and forwarding the information if the random number is even.

In alternative embodiments, however, the determination procedure may use the tossing of a “biased coin.” More particularly, in one embodiment, the determination of whether the new member should be added to the partial view is performed by first randomly selecting a value between one and “x”, where x equals the number of already identified nodes within the partial view. The next step involves comparing the randomly selected value to a predetermined value, e.g., one. If the randomly selected value equals the predetermined value, then the new node information is stored in the partial view. Otherwise, the subscription request is forwarded to one of the existing nodes identified in the partial view and flow 600 begins again as the next node receives the forwarded subscription. Using this selection criterion, nodes receiving forwarded subscription requests choose whether to keep a forwarded subscription with a probability inversely proportional to the length of its current partial view list, i.e., the number of already identified nodes within the partial view.

In yet another embodiment, the predetermined criterion relates to the locality of the new node in relation to the existing member. In this case the probability of keeping a node in a partial view wholly or partially depends the distance between the new subscriber and existing member. Thus, assuming the existing member knows the distance between itself and the new node, it can integrate this information into the predetermined criterion and bias the probability of adding a new node to its partial view accordingly, such as by favoring the storage of closer nodes.

In an embodiment, the combination of partial view size and locality criteria may be used to determine the probability of keeping a new node. For example, an initial operation may set a threshold value for comparing the distance or locality. Next, the actual distance is compared to the threshold value and if the actual distance is smaller than threshold, then the probability of keeping the node can be set according to a formula such as p=1/(1+SizeOfPartialView). Otherwise, if the actual distance is larger and therefore the new node is farther away, the probability of keeping the new node may be set according to a different formula, such as p=1/(10(1+SizeOfPartialView)). The distance value itself may be calculated as the number of hops in the Internet, or alternatively, the distance can be measured by the propagation delay between the new node and the existing node.

If determination operation 612 determines that the new membership information should not be added to the partial view, then flow branches NO to forward operation 608. Forward operation 608, as described above, forwards the new membership information to one member within the existing its partial view. Following forward operation, flow 600 ends at end operation 610.

If test operation 612 determines that the new membership information should be added to the partial view, flow branches YES to store operation 614. Store operation 614 stores the information relating to the new member within the partial view. Store operation 614 is similar to store operation 508 described above in conjunction with FIG. 5.

Upon storing the information, flow 600 ends at end operation 610. Importantly, in the case of a forwarded membership subscription request, once the information is stored within the partial view, the information is not forwarded to any other nodes.

The pseudo-code relating to the process performed by a node receiving a forwarded subscription is shown in Table 2.

TABLE 2
Pseudo-Code for Handling a Forwarded Subscription

Title: Handling of a forwarded subscription
Pseudo Code:
{A node receiving a forwarded subscription adds it with the probability
p =1/(1+SizeOfPartialView) if it does not have it already. It forwards the
subscription to a node randomly chosen in its list if it does not keep it)
keep =RandomChoiceBetween0and1 ()
if (keep<p) and s is not in view then
view.Add(s);
else

int i=RandomChoice(SizeofPartialView);
n=PartialView[i];
send(n,s,forwardedSusbcription);

end if

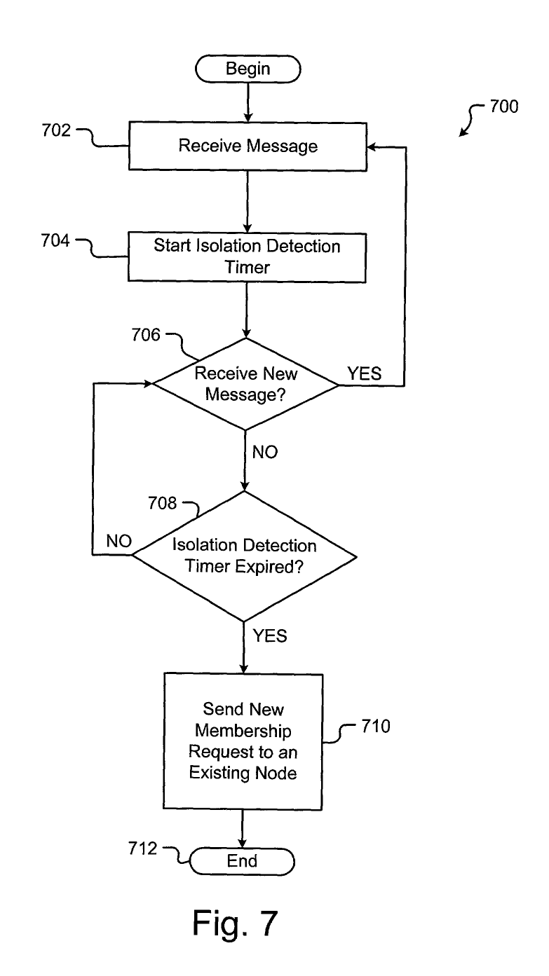

FIG. 7 illustrates the functional operations related to the recovery of the lost node within the environment, such as environment 100 shown in FIG. 1. A node becomes isolated when its identification information is present in no local, partial views of any other node, such that the node will not receive any notifications. Isolation may occur for several reasons, for example, all nodes holding its identification information have either failed or un-subscribed. To overcome isolation, in an embodiment of the invention, all nodes in the environment implement flow 700 to recover from isolation. In those embodiments that utilize the lifetime value property, as discussed above in 110 conjunction with FIG. 3, the lifetime value associated with each subscription may effectively limit any potential isolation time.

Flow 700 generally begins with receive operation 702, which receives a message. Receiving a message relates to the receipt of any message on the network, whether the message is a subscription request, a broadcasted message intended for all nodes, or some other communication such as a “heartbeat” message which is described in more detail below with respect to a particular embodiment. Alternatively, other embodiments may initiate the flow 700 upon the receipt of only a particular type of message, such as broadcast or test message.

Following receive operation 702, start operation 704 starts an isolation detection timer. The isolation detection timer is used to determine whether too much time has elapsed without receiving a message to indicate a possible isolation situation. The timer is set to a predetermined time period.

Following start timer operation 704, test operation 706 tests to see if a new message has been received. If a new message is received, then flow branches YES to receive operation 702. Following receive operation 702, the timer is restarted at operation 704. Thus, as long as new messages are received in a timely manner, the timer will continue to be reset and no isolation occurs.

If test operation 706 determines that no new message is received, then flow branches NO to determination operation 708. Determination operation 708 determines if the timer has expired. If the timer has not expired, flow 700 loops back NO to test operation 706 to see if a new message has been received. Essentially, in an embodiment, while no messages are being received, operations 706 and 708 relatively continuously check for new messages while the timer is running.

If the timer has expired, as determined by determination operation 708, then flow branches YES to send operation 710. Send operation sends a new membership request to an existing node in the environment 100. Essentially, if the timer has expired, then isolation has occurred and the remedy is to re-subscribe. Re-subscribing is the same as subscribing as described above in conjunction with FIGS. 5 and 6. That is, the isolated node sends a request to a node indicating that a subscription or membership is desired and the node receiving the request performs the method shown in FIG. 5, such that the isolated node will become a member once again. The subscription request may be made to an arbitrary member in the isolated nodes partial view.

In order to insure that all nodes receive events in a timely manner, heartbeat notifications may be disseminated though the network when other events are not being broadcast such that nodes that are not isolated receive some sort of message within the predetermined time set by the timer to allow the respective isolation detection timers to be reset. In a particular embodiment, each node maintains two timers: a heartbeat timer and an isolation detection timer. The isolation detection timer operates in a manner similar to that described above in conjunction with FIG. 7. Additionally however, each node maintains a heartbeat timer, which is reset to a predetermined time value upon sending a broadcast or gossip message to all the member nodes identified in its partial view. When the heartbeat timer expires, the node sends a “heartbeat” message to all the nodes in its partial view thus informing them that it is still alive. In an embodiment, these heartbeat messages are not forwarded, i.e., upon receiving a heartbeat message the receiving node does not resend the message to any other nodes. Importantly, the receiving of a heartbeat message from another node not only informs the receiving node that the sending node is still alive, but also indicates that the receiving node is not disconnected and provides the impetus to reset the isolation detection timer as described above. That is, the isolation detection timer is reset to a predefined value each time a message is received, whether the message is a broadcast, a heartbeat or a subscription-related message. Again, if the isolation detection timer expires, the node infers that isolation has occurred and proceeds to resubscribe to the system.

In alternative embodiments, other dummy or false notifications may be disseminated though the network when other events are not being broadcast. Thus, all nodes that are not isolated receive some sort of message within the predetermined time set by the timer to allow the respective isolation detection timers to be reset. Typically, the predetermined time is set to a time value that is much larger than the average time between messages.

Nodes may unsubscribe from a network environment as well. In order to facilitate an act of unsubscribing a node, the node merely conducts a broadcast message indicating a desire to unsubscribe. The unsubscription message may also contain the partial view of the unsubscribing node. Such a broadcast message is then disseminated as any other broadcast message, reaching all members in the network via the gossip based method described above with respect to FIG. 4. Each receiving member may then determine whether that node is in its partial view and remove that information. When a node removes the unsubscribing node from its partial view, it replaces it with a randomly chosen node from the partial view of the unsubscribing node.

In addition to the explicit unsubscribe method described above, nodes may be removed from the partial views of other nodes following the expiration of a lifetime value timer that may be used in some embodiments of the present invention. Essentially, a time value is assigned by the node maintaining the partial view or provided by the subscribing member at the time of subscription. A timer set to the assigned or provided lifetime value is started upon addition of the information to the partial view. Upon expiration of the timer, the information for the node is removed from the partial view. In an embodiment, the node maintaining the partial view may communicate with the node prior to removing the information to determine if the time value should be reset. Other embodiments simply require the expiring node to resubscribe. That is, the expiring node should recognize the time value assigned or provided and therefore can and should send another request to subscribe once the timer related to the lifetime value is about to expire, if a continuous connection is desired.

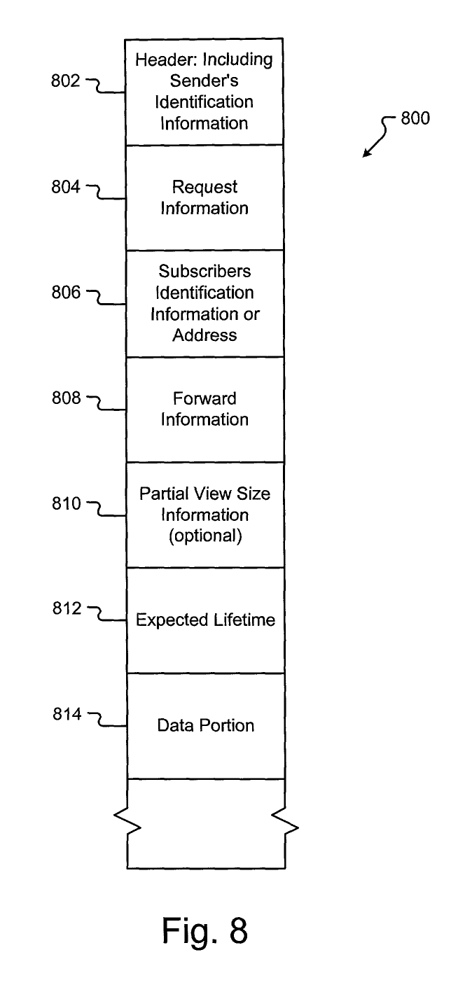

FIG. 8 illustrates an example of a data structure 800 representing a communication between nodes, such as nodes 102, 104, 106, 108, 110 and 112 shown in FIG. 1. More particularly, data structure 800 shown in FIG. 8 represents a communication packet relating to a membership request. In one case, the data structure 800 relates to a request made by a new node, such a node 112, which is requesting a membership to the network or a subscription to particular types of event or message notifications. Alternatively, as discussed below, the data structure 800 may also relate to the forwarding of a membership request between existing nodes in the network.

The request data structure 800 includes a header portion 802 that incorporates general information relating to the routing of the request to another node within a communication network. The header portion 802 typically includes identifying information relating to the sending node and the receiving node and the type of communication protocol used. The communication 800 also has a request for membership information portion 804. The request for membership information portion 804 includes the actual information related to requesting membership. The portion 804 may include some identifying information, such as the type of messages the new node desires to receive. Alternatively, the request may simply request all broadcast or multicast messages.

The communication may further have a new subscriber information portion 806. That is, since the communication 800 may be transferred between existing nodes, the identifying information relating to the new node must be included in the communication request 800 such that forwarded messages indicate the new node information. However, in the case where the data structure 800 is the communication between the new node and an existing node, then the header information may suffice in providing the identifying information for the new node.

In an embodiment of the invention, the communication 800 also has a forwarded indicator portion 808 to indicate whether the request for membership is a forwarded request. That is, the membership request communication 800 is handled differently by existing nodes in the network that receive the request from another existing node than by the existing node that initially receives the request. In general, the existing node that originally receives the membership request broadcasts, through the gossip-based method described below, the new subscription request to multiple nodes. This method insures that the information for the new subscriber node is stored on a plurality of systems. However, a system that receives a forwarded request for membership from an existing node does not broadcast the new subscriber information to a plurality of nodes. Instead, the receiving node either adds the new node to its partial view or it forwards the request to another existing node. Forwarded information portion 808 therefore indicates whether the request is a forwarded request.

In one embodiment of the invention, the communication request 800, when forwarded, includes a size portion 810, which indicates the current size of the forwarding node's partial view. That is, each node within the system maintains a partial view of network that includes a list of addresses or other information relating to a plurality of nodes. In an embodiment, a new node decides to keep a new node depending on the size of its partial view. For instance, if all other nodes have relatively large partial views, then the node with a relatively small partial view tends to keep the new node information. Since ideally all nodes will have the same partial view size, transferring this information allows for the convergence to similar sizes much more quickly. Alternatively however, size information may be left out as discussed below which improves the overhead impact on each individual system.

The communication data structure 800 may also have an expected lifetime or lease value 812 that relates to how long a membership may last. For instance, in the case where communication 800 relates to an initial request to subscribe to a network, the requesting node may provide an indication as to the length of time the membership should last. This value may then be provided to other nodes that maintain information on the requesting node. These other nodes can use the lifetime value information to allot time for the requesting node, and upon expiration of the allotted time, remove the requesting node information from the partial view.

Further, the data structure 800 may also contain a data portion 814, among other portions that can be used to communicate or transfer data between nodes. For instance, if the communication 800 related to a request to unsubscribe, then the data portion 814 may include the partial view information for the unsubscribing member to thereby allow other existing nodes to not only remove the specific information identifying the unsubscribing node but to also replace that information with information identifying one of the nodes listed in the partial view of the unsubscribing node.

Using the above described methods of managing new and forwarded subscriptions, the present invention establishes nodes having partial views that are approximately k=log(n) in size, or alternatively k=c*log(n), where c is a design parameter and where n is the number of existing members or nodes in the environment, especially as the number of nodes increases. Moreover, the methods are decentralized in that no one member maintains complete information for the entire network. Additionally, using the above techniques improves scalability, since k=log(n) grows fairly slowly with respect to the growth of the network (n).

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method of disseminating information to a plurality of nodes, the nodes connected in a network environment, said method comprising:
receiving a disseminated message, the message having broadcast-type information; and
sending the received message to a plurality of other nodes identified in a partial view, wherein the partial view resides locally and identifies some of the other network nodes.

2. A method as defined in claim 1 wherein the act of sending the message to a plurality of nodes further comprises delivery of the message to all nodes identified in the partial view.

3. A method as defined in claim 1 wherein each node in the network maintains a partial view.

4. A method as defined in claim 1 wherein the partial view comprises address information for a plurality of nodes on the network, but less than all nodes on the network.

5. A method as defined in claim 1 further comprising:
determining whether the received message has been previously received; and
if the message has been previously received, then the message is not sent to any other nodes.

6. A method as defined in claim 5 further comprising the act of storing identification information related to the received message to enable the determination of whether the message has been previously received.

7. A method as defined in claim 1 further comprising:
determining whether the message is a broadcast-type message; and
if the message is not a broadcast-type message, the message is not sent to other nodes.

8. A method of generating a partial view of a network, the network comprising a plurality of nodes, the method comprising:
receiving a request to subscribe to the network from a new node;
determining whether to keep the information related to the new node; and
if the new node information is to be kept, storing identifying information related to the new node; and
forwarding the subscription request message to at least one other node in the network.

9. A method as defined in claim 8 wherein the determining act further comprises:
predetermining a threshold value;
upon receipt of the request to subscribe, generating a random number;
comparing the random number to the predetermined threshold value; and
based on the results of the comparison determining whether to keep the information related to the new node.

10. A method as defined in claim 9 wherein the threshold value relates to whether the subscribing node randomly chose the receiving node.

11. A method as defined in claim 8 wherein the subscription request is received by a node having a partial view of the network and wherein the subscription request is forwarded to all nodes identified in the partial view of the receiving node.

12. A method as defined in claim 8 wherein the subscription request is received by a node having a partial view of the network and wherein the subscription request is forwarded to only one node identified in the partial view of the receiving node.

13. A method as defined in claim 11 further comprising:
receiving a forwarded subscription request;
determining whether to keep the new subscription request based on predetermined criterion; and
keeping the new node information if the predetermined criterion is satisfied.

14. A method as defined in claim 8 further comprising:
determining whether the new subscription request is new or forwarded; and
if forwarded, determine whether to keep the information based on a predetermined criteria wherein the predetermined criteria relates to a random selection.

15. A method as defined in claim 14 wherein the predetermined criterion relates to a probability inversely proportional to the size of the partial view for the existing node.

16. A method as defined in claim 15 wherein the predetermined criterion further relates to the distance between the new node and the existing node.

17. A method as defined in claim 15 wherein the act of determining whether to keep the new subscription information first determines whether the new subscription information resides in the partial view of the receiving node and if so, forwards the subscription request to another node identified in the partial view of receiving node.

18. A method of recovering an isolated node in a network environment, the method comprising:
receiving a broadcast message;
starting a timer;
if timer expires before receiving another message, sending another subscription request to a node identified in the partial view of the isolated node; and
if a new message is received before the timer expires, restarting the timer.

19. A method as defined in claim 18, further comprising:
broadcasting a heartbeat message to other nodes in the environment to prevent premature isolation.

20. A computer system for disseminating information in a distributed network comprising:
a receive module for receiving a broadcast message;
a storage module for storing information related to other nodes in the network in a partial view; and
a communication module for transmitting broadcast information to nodes indicated in the partial view.

21. A computer system as defined in claim 20 wherein the partial view comprises address information for some of the nodes in the network.

22. A computer system as defined in claim 20 wherein the communication module transmits broadcast information to all nodes identified in the partial view.

23. A computer system as defined in claim 20 wherein the computer system is part of a distributed network of computer systems, and wherein other computer systems in the network maintain a partial view of the entire network.

24. A network of nodes having the ability to communicate information between said nodes, said network comprising:
an application-based broadcast protocol using a gossip-based algorithm;
each node maintains a partial view of the entire network; and
each node gossips only to other nodes identified in the partial view.

25. A computer readable medium having stored thereon a data structure comprising:
a first identification field for storing address location information for a node in a network environment;
a second identification field for storing address location information for another node in a network environment;
wherein the first and second identification fields represent a partial view of the network environment; and
wherein the data structure is used for a gossip-based communication between the nodes in the network.

26. A data structure as defined in claim 25 having a plurality of additional identification fields, each field identifying address information for different nodes in the network.

27. A computer readable medium having stored thereon a data structure representing a subscription request for requesting membership into a network comprising:
header information portion having sender node and receiver node information;
request information portion for requesting membership into the network;
a forwarded information portion that indicates whether the subscription request is forwarded or new; and
new subscriber node identifying information portion for uniquely identifying the location of the new subscriber node.

28. A data structure as defined in claim 27 further comprising protocol information related to the gossip-based protocol used in the network.

29. A data structure as defined in claim 28 further comprising size information relating to the size of the partial view of the sending node.
